(19) United States
(12) Patent Application Publication
(10) Pub. No.: US 2004/0102297 A1
(43) Pub. Date: May 27, 2004

(54) Machine tool

(76) Inventors: Andreas Quak, Erkarth (DE); Hans-Joachim Dey, Erkarth (DE)

Correspondence Address: Diller Ramik & Wright, Merrion Square Suite 101, 7345 McWhorter Place, Annandale, VA, 22003, US

(21) Appl. No.: 10/398,194

(22) PCT Filed: Oct. 6, 2001
(86) PCT No.: PCT/EP01/11541

(30) Foreign Application Priority Data
Oct. 9, 2000 (DE) 10049810.8

(51) Int. Cl. B23Q 3/157

(52) U.S. Cl. 483/56; 409/198

(57) ABSTRACT

The machine tool comprises a vertical support (10) with a guide (11) arranged thereon for vertical movement of a workpiece carrier (13) holding a workpiece (15) along an X-axis. Two headstocks (24,30) are each movable along horizontal guides (27,28) in the Y-direction. The guides (27,28) form a frame, with its window (23) closed by a louver provided with passage openings for the headstocks (24,30). This arrangement creates a laterally closed machining chamber which comprises vertical walls and does not present any obstacles to falling chippings. Since the chippings need not be washed off, spray cooling may be used for minimum-quantity lubrication. In this manner, the liquid acting on the chippings is reduced.

### BACKGROUND OF THE INVENTION

The present invention relates to a machine tool for the machining of workpieces, particularly a machine tool comprising a tool magazine allowing for an exchange of tools by moving the headstocks in pick-up operation.

A machine tool according to the preamble of claim 1 is known from DE 32 36 356 C2. This machine tool comprises a vertical support on which a workpiece carrier is arranged for vertical displacement. On a machine base, a spindle head is arranged which is horizontally displaceable and further is movable in the axial direction of the spindle. Also arranged on the machine base is a circulating tool magazine provided with a tool exchange means. The tool exchange means is arranged for the transfer of tools from an exchange position of the tool magazine to the headstock (and vice versa) when the headstock has arrived in a position provided for this purpose. Since the workpiece to be machined and the headstock are oriented horizontally, chippings generated during the machining can drop freely without hitting the workpiece carrier or settling down on the workpiece carrier or the workpiece.

EP 0 806 998 B1 describes a machine tool comprising two vertically displaceable headstocks each of which can act individually on a workpiece attached to the workpiece carrier, while the other headstock can carry out an exchange of tools on a tool magazine. The tool magazine is configured as a circulating magazine and arranged such that each headstock has its own exchange position on the tool magazine. The machine tool is suited for quick and effective machining of workpieces by use of different tools. A difficulty is caused in that a fast operation on workpieces tends to generate a considerable amount of chippings which are heavily loaded with cooling liquid. These chippings will drop onto the guide track of the workpiece carrier. Although this guide can be provided with a lamellar cover precluding disturbances of the running of the workpiece carrier, the generated chippings will add up to form larger accumulations, resulting in congestion and hindrances of the discharge of the chippings. For the discharge of chippings, oblique walls leading to a chip conveyer are provided below the guide of the workpiece carrier. The cooling liquid is supplied in large quantities and is also used to safeguard the discharge of chippings and to preclude clogging caused by chippings.

### SUMMARY OF THE INVENTION

It is an object of the invention to provide a machine tool with workpiece carriers, headstock and tool magazine which is suited for a quick machining of workpieces and is not prone to disturbances caused by chippings generated in fast operation.

According to the invention, the above object is achieved by the features indicated in claim 1. Thus, the workpiece carrier, having a horizontal axis of rotation, is mounted on a vertical support, and the (at least one) headstock is guided on a horizontal guide along the horizontally extending first axis of movement. In the machine tool according to the invention, the guide of the workpiece carrier is arranged vertically so that the workpiece extending from the workpiece carrier will project freely into space in a cantilevered manner while the chippings from the workpiece can drop unhindered. The space under the workpiece attached to the workpiece carrier is free from any constructional parts which might obstruct the path of the dropping chips. The chips can descend in free fall to the ground where a chip conveyer or another device for discharge of the chippings is arranged.

The invention offers the advantage of obviating the need for a cooling agent for washing the chippings away. Thus, the cooling process can be performed through economical supply of a cooling agent, e.g. by means of spray cooling. In spray cooling, the spray liquid is spayed in droplets onto the workpiece. This results in lubricating and cooling characteristics similar to those of a liquid jet while, however, the consumption of cooling liquid is considerably lower. Advantageously, less cooling agent will adhere to the chippings and the removal of cooling agent from the chippings will require less expenditure. Further, the minimum-quantity lubricating which is rendered possible by spray lubrication will lengthen the operational life of the tool and allow for an improved surface quality of the workpiece. Due to the improved discharge of the chippings, the machine tool of the invention is suited to have spray lubrication performed thereon.

A further advantage resides in that the headstock has direct access to the vertical front strand of the tool magazine so that no tool exchange device is required. Each headstock will be able to fetch the required tool from the front strand of the tool magazine; for this purpose, the headstock is moved into the exchange position where it can take over the tool directly from the tool magazine.

According to a preferred embodiment of the invention, the guide of the headstock is a component of a rectangular frame which encloses a window in which the headstock is allowed to move. The window is provided with a louver having an opening arranged therein which is capable of adapting to the position of the headstock. In combination with the louver closing the window, the rectangular frame forms a vertical wall, allowing the chippings to fall down therealong.

Preferably, the support in combination with the guide of the headstock forms an L-shaped structure in plan view which together with complementary walls and doors, respectively, encloses a machining chamber on the lateral sides. In this manner, there is obtained a laterally continuously enclosed machining chamber with exclusively vertical walls and without inner fittings which would impair the fall of the drillings.

The machine tool of the invention is preferably used as a two-spindle machine wherein respectively one headstock performs the machining while the other headstock can carry out an exchange of tools. Both spindles are adapted for movement along horizontal guides arranged with a vertical distance from each other. Each of the guides is arranged relative to the tool magazine in such a manner that the headstock can perform the exchange of tools in pick-up operation. In the process, the headstock will be moved behind the tool holder—placed in its exchange position—of the tool magazine while the tool fastened to the headstock is transferred to the tool holder directly and without the use of a tool exchanger. In a similar manner, the headstock fetches the tool from the tool magazine by direct access along the Z-axis.

If a lower guide is provided, with its upper side designed for movement of the headstock therealong, the guide is suitably joined in a downward direction by a skirt connected to a collecting means for chippings. The skirt constitutes a component of the vertical wall provided for the discharge of chippings exclusively through gravitational force. This collecting means is preferably provided as a chip conveyer.

With the invention, it is further possible to provide two tool magazines in a common vertical plane, notably on both ends of the guide for the headstock.

According to a further alternative embodiment of the invention, two workpiece carriers are provided to engage the workpiece under treatment from two opposite sides. For this purpose, two vertical supports can be provided, each of them comprising a vertical guide for a workpiece carrier. The vertical guides are covered by a lamellar louver or a similar vertical cover means, thus precluding the intrusion of chippings. This also applies for the tool magazine. Projecting into the machining chamber are only those parts of the tool magazine which are required for an exchange of tools. All other parts are located behind the respective limiting wall of the machining chamber, and the passages of the tool magazine through this partitioning wall are closed by a chip sealing.

Embodiments of the invention will be explained in greater detail hereunder with reference to the drawings.

### BRIEF DESCRIPTION OF THE DRAWINGS

FIG. 1 is a schematic perspective view of a first embodiment of the machine tool.

FIG. 2 is a plan view of the machine according to FIG. 1.

FIG. 3 is a lateral view of the machine according to FIG. 1, partially sectioned along the line III-III of FIG. 1.

FIG. 4 is a view illustrating the configuration of the machine tool with two tool magazines.

FIG. 5 is a view of the machine tool with two workpiece carriers to be moved in synchronism.

FIG. 6 is a view of a modification of the machine tool according to FIG. 5.

### DESCRIPTION OF THE PREFERRED EMBODIMENTS

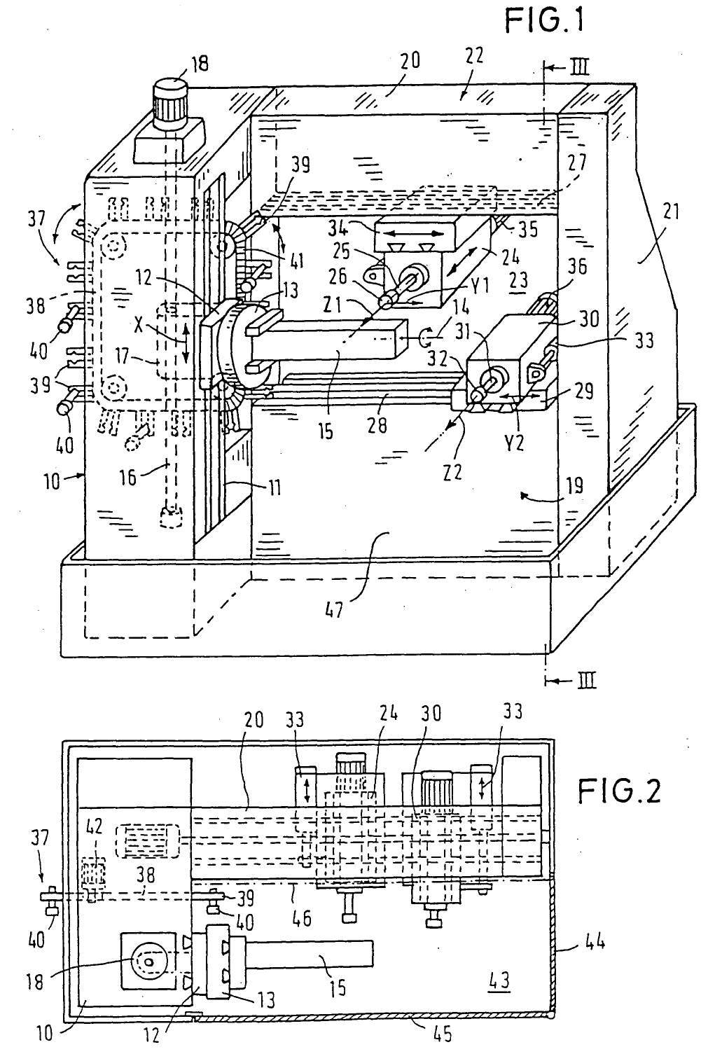

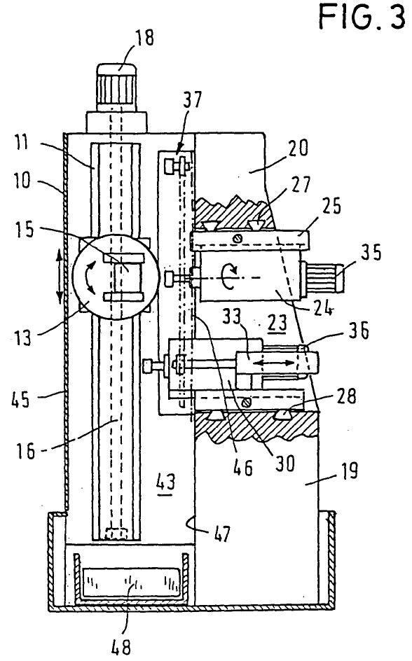

The machine tool as illustrated in FIGS. 1-3 comprises a vertical support 10 provided with a vertical guide 11 arranged to have a carriage 12 vertically moved thereon in a controlled manner. On carriage 12, a workpiece carrier 13 is supported for controlled rotation about a horizontal rotational axis 14. The workpiece 15 to be machined will be fastened to workpiece carrier 13. The movement of the carriage 12 along the vertical X-axis is performed by a spindle drive provided internally of support 10 and comprising a spindle 16, a spindle nut 17 connected to carriage 12, and a motor 18 rotating the spindle 16. Motor 18 is a NC drive (NC=numerically controlled) allowing for a highly accurate height adjustment of workpiece carrier 13. Mounted to carriage 12 is a further NC drive (not shown) for rotating workpiece carrier 13.

A lower beam 19 and an upper beam 20 extend horizontally from support 10. The beams are arranged at a mutual distance and together with the support 10 and a vertical post 21 form a rectangular frame 22 enclosing a rectangular window 23. Arranged in window 23 is a first headstock 24 comprising a rotatably driven spindle 25 with a tool 26 fastened thereto. Headstock 24 is arranged to be moved on a carriage 34 in the direction of an axis of movement Z1 extending axially to spindle 25. Carriage 34 is movable in a horizontal guide 27 along a first axis of movement Y1 extending at a right angle to the axial direction of spindle 25, while traveling in the lengthwise direction of guide 27. The movements along the axes Y1 and Z1 are carried out by headstock 24. The movement along the X-axis and the rotation about rotational axis 14 are carried out by workpiece 15. The mounting surface of the workpiece carrier has a normal line which coincides with the rotational axis 14 and extends parallel to the first axis Y1.

The upper side of beam 19 is provided with a horizontal guide 28 for a carriage 29 having a second headstock 30 arranged thereon. Headstock 30 comprises a spindle 31 with a tool 32 fastened thereto. Headstock 30 is movable on guide 28 along the first axis of movement Y2 and further along a second axis of movement Z2 extending axially to spindle 31. The movement along axis of movement Z2 is generated by a linear drive 33.

Each of the two spindles 25,31 is rotatably driven by a motor 35 and 36, respectively, of the respective headstock.

On support 10, a tool magazine 37 is mounted which is provided with a circulating continuous endless conveyer 38 equipped with tool carriers 39 projecting therefrom to the outside. Each tool carrier 39 comprises two fingers configured for clamping the shaft of a tool 40 therebetween. The tool magazine 37 is arranged in a vertical plane extending parallel to the movement axes Y1 and Y2. The vertical front strand 41 of the tool magazine projects out of support 10 and comprises two exchange positions, respectively one for each headstock 24 and 30. A tool 40 arranged in an exchange position can be gripped and taken over by the spindle of the respective headstock 24 or 30. On the other hand, each headstock 24,30 can hand over a tool 26,32 attached to its spindle 25,31 to that workpiece holder 39 of tool magazine 37 which is arranged in the exchange position. The drive of continuous conveyer 38 is controlled by a motor 42.

As evident from FIG. 2, the vertical support 10 together with the horizontal beams 19 and 20 in plan view forms an L-shaped structure enclosing a machining chamber 43. Machining chamber 43 is further delimited by a side wall 44 and a front wall 45 or door, thus being completely enclosed on the sides. The window 23 surrounded by frame 22 is closed by a louver 46 which is not shown in FIG. 1. The louver is a lamellar louver comprising two longitudinal slots, one for each headstock 24,30. The slots are closed by lamellae configured to adapt to the respective position of headstock 24,30 in the direction of the axis of movement Y1 or Y2 and allowing only the headstock 24,30 to pass while the rest of the window 23 will remain closed. The front wall of beam 19 is formed by a vertical skirt 47. Thus, the machining chamber 43 is delimited exclusively by vertical walls. Arranged on the lower end of machining chamber 43 is a chip conveyer 48 which can be provided e.g. as a belt or chain conveyer but also as a screw conveyer. The conveyer is sized to occupy the whole width of machining chamber 43 and will remove the dropped chippings from the machine tool.

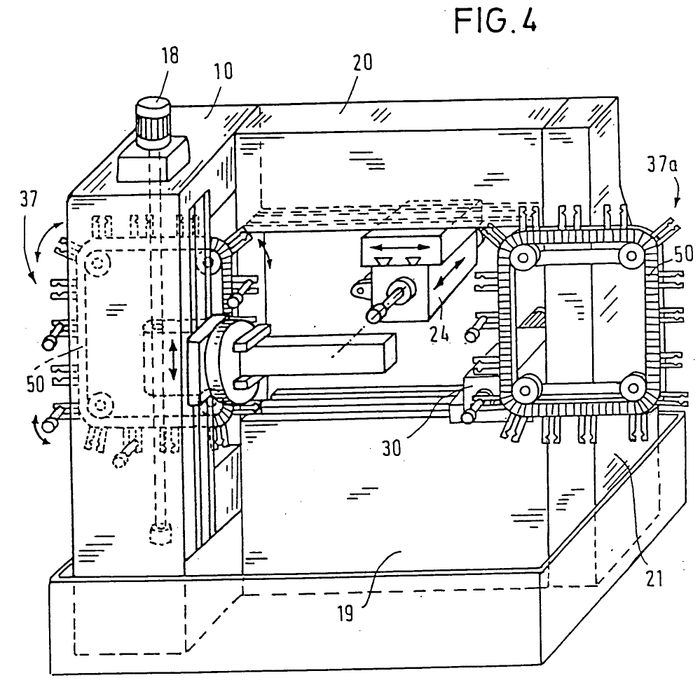

The embodiment according to FIG. 4 is different from the first embodiment only in that, apart from the tool magazine 37 on support 10, a further similar tool magazine 37a is arranged on the post 21. Both tool magazines are arranged at the same height and delimit the moving path of the headstocks 24,30 in the horizontal direction, wherein each headstock 24,30 can access each of the tool magazines 37,37a arranged in a common vertical plane.

In both tool magazines 37,37a, the rear or outer strand 50 is arranged externally of support 10 and post 21 and thus will be accessible from the outside for manual exchange of tools.

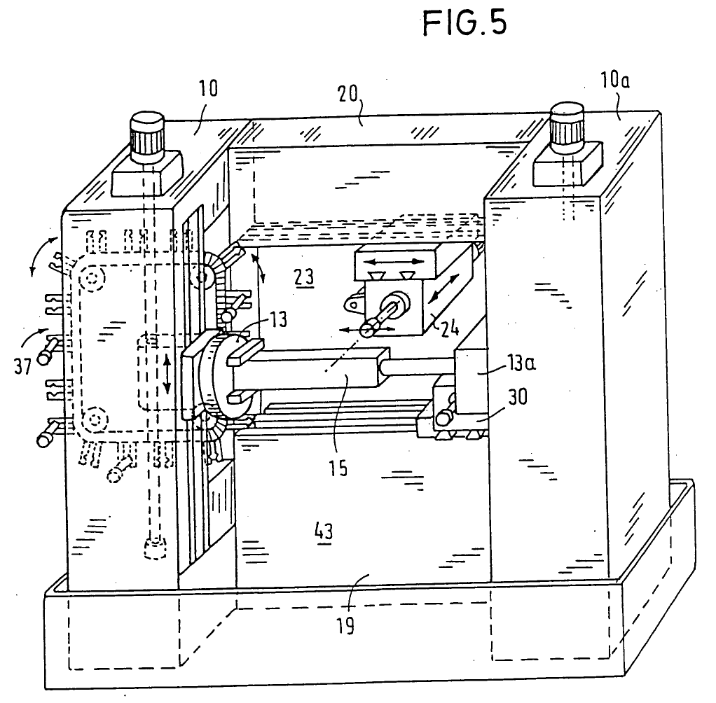

In the embodiment according to FIG. 5, a further support 10a is provided in addition to support 10, replacing post 21. Support 10a comprises a second workpiece carrier 13a arranged for controlled movement along a vertical guide and for rotation about its horizontal longitudinal axis. The workpiece 15 can by each of its ends be clamped into a workpiece carrier 13 and 13a, respectively. The workpiece carriers 13 and 13a are moved in synchronism with each other in the vertical direction and are also rotated in synchronism. This two-sided clamping attachment of the workpiece provides for a highly precise positioning even of bulky or heavy workpieces.

On the other hand, an option exists to fasten e.g. an auxiliary bar to one workpiece carrier 13a; the bar will be attached to the workpiece and support the same on the respective side.

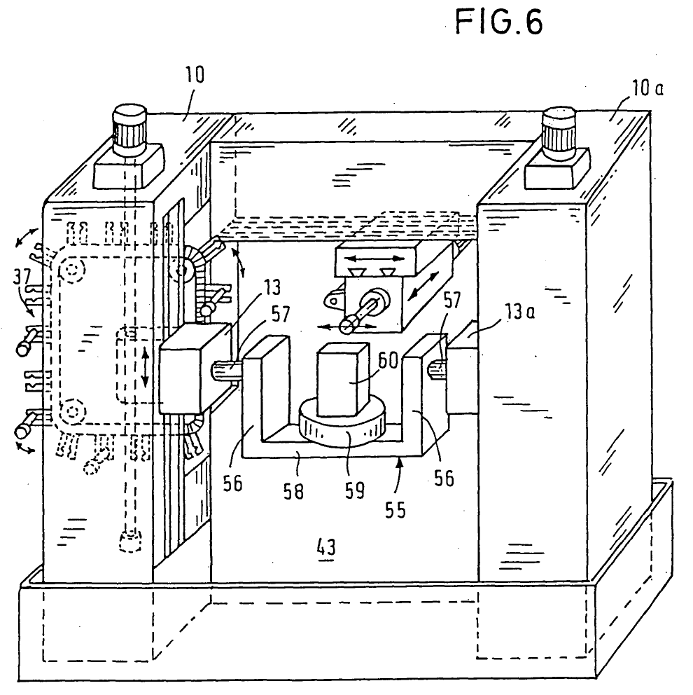

In the embodiment shown in FIG. 6, which largely corresponds to that according to FIG. 5, the two workpiece carriers 13,13a hold a U-shaped holder 55 clamped between them which has its legs 56 attached to the workpiece carriers by axes 57. The base 58 of holder 55 carries a rotary table 59 for attachment of the workpiece 60 thereon. By pivoting the holder 55 about the axes 57, the workpiece 60 can be brought into an oblique position so that, using the tool fastened to the respective headstock 24,30, an angular machining process can be carried out. The pivotable holder 55 allows for a quick repositioning of workpiece 60 for performing machining processes on different sites or in different directions.

In each of the embodiments according to FIGS. 4-6, a laterally closed machining chamber 43 is provided; in these Figures, the walls 44 and 45 have been omitted for easier survey. In any case, chippings will fall down along vertical walls onto a collecting means 48 for chips, e.g. a chip conveyer, without being hindered by fittings.

In each of the embodiments, all functions of the machine tool are controlled numerically according to predetermined programs so that the machining of workpieces and the exchanging of tools can be performed fully automatically. Also the control of the tool magazine 37,37a is fully automated, wherein the respectively required tool 40 is brought into the exchange position. Likewise, the exchange of workpieces 15 and their delivery and removal are performed in a controlled manner.

What is claimed is:

1. A machine tool comprising a workpiece carrier (13) arranged on a vertical support (10) for rotation about a horizontal axis of rotation (14), at least one headstock (24) arranged on a horizontal guide (27) extending at a right angle to the axial direction of the spindle (25) for controlled movement along a first axis of movement (Y1) and along a second axis of movement (Z1) extending in the axial direction, and at least one tool magazine (37), characterized in
that the tool magazine (37) is arranged in a vertical plane extending parallel to the first axis of movement (Y1), and comprises a vertical front strand (41) which extends parallel to the support (10) and at the height of each headstock (24) has an exchange position for direct access by the headstock.

2. The machine tool according to claim 1, characterized in that the guide (27) of the headstock (24) is a component of a rectangular frame (22) enclosing a window (23) allowing movement of the headstock (24) therein, and that the window (23) is provided with a louver (46) having an opening capable of adapting to the position of the headstock (24).

3. The machine tool according to claim 1 or 2, characterized in that the support (10) together with the guide (27) of the headstock (24) forms a structure which has an L-shaped configuration in plan view and together with complementary walls (44,45) and doors, respectively, encloses a machining chamber (43) on the lateral sides.

4. The machine tool according to any one of claim 1-3, characterized in that a lower guide (28), carrying a headstock (30), is provided and that the lower guide (28) is joined in a downward direction by a skirt (47) connected to a collecting means (48) for chippings.

5. The machine tool according to any one of claim 1-4, characterized in that two tool magazines (37,37a) are provided in a common vertical plane.

6. The machine tool according to any one of claim 1-5, characterized by the provision of two vertical supports (10,10a) each comprising a workpiece carrier (13,13a), both workpiece carriers being rotatable and adjustable in height in synchronism with each other.

7. The machine tool according to claim 6, characterized in that the workpiece carriers (13,13a) carry the legs of a U-shaped holder (55) having a rotary table (59) mounted on its base (58).
